(19) United States
(12) Patent Application Publication
(10) Pub. No.: US 2021/0047863 A1
(43) Pub. Date: Feb. 18, 2021

(54) STORING AND RETRIEVING OF SECURED ARTICLES

(71) Applicant: Wells Fargo Bank, N.A., San Francisco, CA (US)

(72) Inventors: H. Brock Kolls, Alpharetta, GA (US); Thomas Evans, San Francisco, CA (US)

(21) Appl. No.: 15/630,378

(22) Filed: Jun. 22, 2017

(51) Int. Cl. E05B 39/04; G07C 1/32

(52) U.S. Cl. CPC E05B 39/04; G07C 2009/00095; G07C 1/32

(57) ABSTRACT

Depositing and retrieving articles in/from security boxes held in secure, remote repositories is facilitated by providing an integrated system for article owners, people with permission to access articles, storage trustees, and transport trustees that securely transports articles from a repository to a meeting point at which the owner or other authorized accessor can retrieve the article(s). The boxes can contain multiple compartments for different articles. Access permissions can vary from article to article, and an inventory of articles and their access permissions can be maintained.

### BACKGROUND

Some financial service or storage service providers offer safety deposit boxes in which users of the services can store one or more articles (typically of high value) in a secured container that is held in a secured storage area of a repository. Typically, to retrieve the stored articles the owner of the articles travels to the repository during its open hours and requests retrieval of their box. The owner's accessing the contents of the box takes place in a secure location at the repository, and the owner returns the box to its secure location before leaving the repository.

### SUMMARY

The present disclosure deals with improvements in the storage, retrieval and management of containers that securely hold one or more articles.

The containers of the present disclosure will be referred to herein as boxes, though any form of securable (i.e., lockable and unlockable) enclosure adapted to hold one or more physical objects is intended by the term “box.” Each box is configured to hold one or more articles belonging to one or more owners and is designed to minimize the possibility of unauthorized access to the contents of the box. Thus, the box can include one or more security features, such as locks, armor, alarms, other forms of deterrence (e.g., electrified), and so forth.

Owners can elect to store any articles they choose in a box, provided the articles meet the box's article storage conditions, such as size and safety conditions. Non-limiting examples of such articles include: money, jewelry, precious metals, artwork, antiques, firearms, Wills, Deeds and other important documents, etc. Typically, though not necessarily, it will be the owner or the agent of an owner who initially deposits a given article in a given box.

In addition to owners, each box can be associated with one or more authorized accessors (“AA”) of the box. An AA can be, but need not be, the owner of the article contained in a box, and is in any event authorized at some point in time to access at least one article contained in the box in question. It should be appreciated that owners and AA's can be natural people as well as other types of entities that can designate one or more human agents to act on their behalf.

Storage of each box is entrusted to a third party, i.e., an entity other than the owner of the articles stored in the box. Such third parties will be referred to herein as storage trustees. Non-limiting examples of storage trustees can include banks or other financial institutions, storage companies, or any entity that provides secure storage services for personal property.

In some examples, a storage trustee can also act as a transport trustee, i.e., an entity entrusted with the security of a given box while it is in transit. Alternatively, a transport trustee can be another third party entity that is not the storage trustee. Non-limiting examples of such transport trustees include courier entities, mailing/shipping entities, etc.

In some examples, the storage trustee will own and/or operate a repository that can store a plurality of boxes in one or more secure areas, such as a vault. The repository can also include one or more secure retrieval areas where AA's can securely “meet” their box and access its contents.

In some examples, the transport trustee will own and/or operate one or more delivery vehicles, such as armored cars, armored trucks, armored boats, or armored flying vessels (such as drones) for securely transporting boxes.

In some examples, the storage trustee and/or the transport trustee will own and/or operate one or more courier vehicles adapted to securely carry one or more boxes from a delivery vehicle to a “meeting point” remote from the repository where the AA can access the box. Non-limiting examples of courier vehicles include armored wheeled vehicles, armored floating vessels, or armored flying drones. As used herein a “meeting point” is a location where an AA can physically access a box.

The delivery vehicles can be operated autonomously, or by humans on site or remotely. By “autonomous” it is meant that the vehicle can transport itself with little or no human intervention, e.g., by processing pre-existing encoded instructions in response to given stimuli. An “on site” operator is a human who is physically present in or on the vehicle to operate it. In a remote operation, a human who is not in or on the vehicle (e.g., the human is located in a control center), is actively monitoring the vehicle and sends commands to the vehicle (e.g., via a remote control) to which the vehicle responds by performing maneuvers consistent with the commands. It should be appreciated that delivery vehicles can have varying degrees of autonomy, in which certain maneuvers are pre-programmed and certain other maneuvers are performed in direct response to a human initiated command.

The courier vehicles can be operated autonomously or remotely. In addition, or alternatively, a human operator can accompany the courier vehicle and act as a security guard. Likewise, human security guards can be utilized wherever and whenever appropriate, e.g., to accompany a box to a meeting point at a repository or outside of a repository, to ride in a delivery vehicle, etc.

In accordance with certain aspects of the present disclosure, an integrated system for managing secured articles includes one or more storage trustees, one or more transport trustees, and one or more AA's associated with one or more boxes, all interconnected over a network such as the Internet. Such a system can include one or more servers that store and process information related to the system, and execute instructions provided by one or more entities that use the system, such as an AA or a trustee. Communication between the different components of the system can be routed via the network, and any commands/requests, such as those from individual AA's, can be submitted to the system via in an input-output (“IO”) device (such as a smart phone, tablet, wristwatch, or other computerized device) that connects to the network.

According to certain aspects of the present disclosure, a box can include one or more compartments. AA's can be authorized to access the entire contents of the box, or alternatively just a subset of the contents. In the latter case, a box can include multiple independently securable/lockable compartments, with different articles stored in different compartments and different access permissions assigned to the different compartments.

According to certain aspects of the present disclosure, owners and/or AA's can create and manage virtual inventories of the boxes with which they are associated, such that an AA can select in advance a particular article or articles to access at the meeting point. In some examples, an inventory is a photo inventory including visual images of the articles stored in a box. In some examples, the visual images are selectable by the owner/AA. In some examples, the inventory can reflect a current status of one or more articles, depending on whether an article is in the box, temporarily removed from a box, or permanently removed from the box.

According to certain aspects of the present disclosure, information regarding deposit and retrieval activity for a box is monitored and stored, and accessible by owners, AA's, storage trustees, and/or transport trustees associated with the box.

According to certain aspects of the present disclosure, for a given box there can be associated therewith an exclusive AA, multiple co-dependent AA's, or multiple independent AA's. A box associated with co-dependent AA's is one that can be accessed only when all the co-dependent AA's (e.g., all of the children of a deceased father) authorize its access and/or are present at the meeting point. A box associated with multiple independent AA's (e.g., a husband and wife) is one that can be accessed by any single one of the independent AA's associated with that box. The owner of the articles stored in the box determines who the AA's are and the nature of their association with the box (e.g., exclusive, co-dependent, independent). The owner can also authorize others to determine who the AA's are or will be in the future for a given box.

According to certain aspects of the present disclosure, owners/AA's can choose to summon boxes with which they are associated to deposit or retrieve one or more articles on any day at any time of day in the future.

According to certain aspects of the present disclosure, owners/AA's can choose to retrieve one or more objects from a box for a pre-set period of time, the box returning to the repository in the interim between the retrieval and the subsequent re-depositing.

According to certain aspects of the present disclosure, the location of a meeting point between one or more owners/AA's and their associated box or boxes can be determined by the owner/AA. In some examples, the location of the meeting point can alternatively be determined by another entity, such as the storage trustee. In addition, meeting point locations can be negotiated between owners/AA's. For example, an AA can request to meet a box at a location X, and then the storage trustee can set the meeting point as the location closest to X with at least a predefined threshold level of security.

According to certain aspects of the present disclosure, AA permission settings can be time-dependent, e.g., an AA is permitted access to a given box for a specific period of time that starts and/or ends at a predefined time in the future. The start and end times can be triggered by external events, such as a death, a divorce, an incapacity, a marriage, a birth, etc.

According to certain aspects of the present disclosure, boxes can be equipped with AA verification features to minimize the chance of an unauthorized access to the box. Such verification features can include, for example, one or more of: key-entry locks (to which only AA's hold the key), password-entry locks (to which only AA's hold the password), biometric scanners, etc. The system can include a database of AA identifying information, which can be cross-referenced with information input or otherwise available about a person attempting to access a box to confirm or disconfirm the person's authorization to enter the box.

According to certain aspects of the present disclosure, boxes can be equipped with one or more detectors. Detectors can be used, for example, to detect tampering with the box such as an attempt to force the box open. Detectors can also be used to minimize potential safety risks posed by box contents. For example, detectors can be used that can sense particular chemicals (such as explosives) or biological agents, and the box can be configured to disallow depositing of such unsafe articles inside.

Systems in accordance with the present disclosure can also facilitate payment of fees for the services provided by the system. For example, an owner of an AA can pay one or more fees for the storage and/or retrieval of articles in boxes. The fees can be collected by the storage trustee, the transport trustee, or another entity associated with them. The system can be configured as a “pay as you go” service, e.g., in which an owner/AA pays each time they retrieve or return a box to the repository; as a membership/box rental service, e.g., in which an owner/AA pays a periodic subscription fee for one or more services provided by the storage or transport trustees; or as a combination of payment structures.

### DESCRIPTION OF THE DRAWINGS

FIG. 1 is a block diagram illustrating an example of a safety box management system in accordance with aspects of the present disclosure.

FIG. 2 is a schematic illustration of an example user device of FIG. 1.

FIG. 3 is a schematic illustration of an example safety box 106 of FIG. 1.

FIG. 4 is a flow diagram illustrating an example of an article depositing process that can be performed in conjunction with the system of FIG. 1.

FIG. 5 is a flow diagram illustrating an example of an article retrieval process that can be performed in conjunction with the system of FIG. 1.

FIG. 6 depicts an example interface display showing an example input screen on a user device of FIG. 2.

FIG. 7 depicts a further example interface display showing an example input screen on a user device of FIG. 2.

FIG. 8 depicts a further example interface display showing an example input screen on a user device of FIG. 2.

FIG. 9 depicts a further example interface display showing an example input screen on a user device of FIG. 2.

FIG. 10 depicts a further example interface display showing an example input screen on a user device of FIG. 2.

FIG. 11 is a block diagram illustrating portions of an example computer system of the system of FIG. 1.

### DETAILED DESCRIPTION

In the following Detailed Description, reference is made to the accompanying drawings, which form a part hereof, and in which is shown by way of illustration specific embodiments which may be practiced. The following detailed description, therefore, is not to be taken in a limiting sense.

Features of the systems and methods for managing safety boxes can benefit the various parties involved, such as the owners, the AA's, the storage trustees, and the transport trustees. For example, owners/AA's associated with valued articles benefit from the added flexibility in when, where, how, and for how long articles are deposited and retrieved and who can access the articles and under what circumstances, without sacrificing or minimally sacrificing, and in some cases improving, the security of those articles. Storage and other trustees can benefit, e.g., from the availability of additional revenue streams accompanying the increased flexibility in how owners manage their valuables.

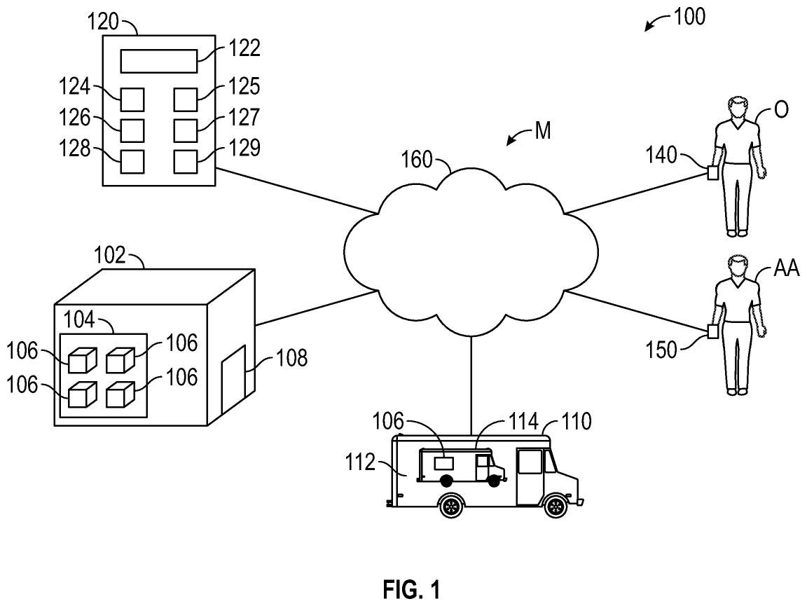

FIG. 1 is a block diagram illustrating an example of a safety box management system 100 in accordance with aspects of the present disclosure. The system 100 includes a repository 102. The repository 102 can be, e.g., a physical building designed to minimize theft and destruction of objects it holds. The repository 102 includes a vault 104 that securely holds a plurality of boxes 106, each containing one or more articles belonging to a plurality of owners. The repository can also include one or more entry/exit features 108, such as door to permit selective entry and exit of people and/or vehicles. The repository 102 can be owned and/or operated by a storage trustee.

The example system 100 also includes a delivery vehicle 110. The delivery vehicle 110 transports one or more boxes 106 between the repository 102 and a meeting point M where an owner O and/or other AA accesses the box 106. The delivery vehicle 110 can be configured to, e.g. roll on wheels, to fly, and/or to float and move on water. The delivery vehicle 110 can be armored. The delivery vehicle includes an internal chamber 112 that can house the boxes 106 during transport. In this example, the internal chamber 112 is configured to carry a courier vehicle 114. In some examples, the delivery vehicle 110 is autonomous and/or remotely controlled.

The courier vehicle 114 is smaller than the delivery vehicle 110. The courier vehicle 114 can be armored and carry one or more boxes 106 from the delivery vehicle 110 to the meeting point M. The courier vehicle 114 can be figured to roll, fly, and/or float. The courier vehicle 114 can be used in situations in which the delivery vehicle is too large or otherwise unsuitable to travel all the way to the meeting point M. For example, the meeting point M could be the AA's apartment on the 10^{th} floor of an apartment building. In that example, the AA's box 106 is retrieved (by a person or robotics) from the repository and placed in in the courier vehicle 114, which is itself placed in the delivery vehicle 110. The delivery vehicle 110 can park outside the apartment building, and the courier vehicle 114 exits the delivery vehicle 110, takes an elevator in the apartment building to the 10^{th} floor and then travels to the AA's apartment where the AA can then authenticate their identity and thereby gain access to the box 106. In some examples, the courier vehicle 114 is autonomous and/or remotely controlled.

In some examples, the system 100 is configured such that the AA can track the location of the box 106 as it travels from the repository 102 in the delivery vehicle 110 and/or the courier vehicle 114 towards the meeting point M and thereby reduce or eliminate delays in the retrieval process.

The example system 100 also includes a server 120. In some examples, the server 120 can be one of a network of servers (e.g., a “cloud”) of the system 100. In some examples, each server in the network of servers can be adapted to perform a specific function or functions on behalf of the system 100. Although specific functionalities will be attributed to the server 120 in this disclosure, it should be appreciated that the same functionalities can be divided among a network of interconnected servers. Thus, throughout this disclosure, the server 120 can alternatively be understood as a single server or a network of servers.

The server 120 includes one or more computing devices configured to operate together. The server 120 includes one or more databases 122 and one or more modules containing instructions executable by a computer processor, the one or more databases being accessible to the one or more modules.

The database 122 can be a single database or a network of databases and, for purposes of this disclosure, can be either. The database 122 or network of databases, are readable and writable repositories of data required by the system 100 to provide safety box management functionalities in accordance with principles of the present disclosure. Thus, the database(s) store(s) data used by the system 100. Examples of data used by the system 100 include: data relating to the boxes 106 (such as box identification, location, size, capacity, number of internal compartments, etc.); and data about owners and AA's, such as contact information, biometric identifying and other authentication information, financial account information, etc.

The database(s) 122 can also store, for example, data relating to permissions assigned to owners and AA's with respect to specific boxes, article inventories of the boxes 106, histories of the articles including when, where, how, and who made deposits to and retrievals from the boxes 106, etc. The database(s) 122 can also include membership information, payment information, etc. The database(s) 122 can also include, e.g., one or more maps defining a geographic region or regions in which boxes from the repository 102 could be delivered to owners/AA's. In addition to the map(s), the database(s) 122 could also store one or more pre-defined set(s) of safe (and/or unsafe) locations for meeting points within the defined geographic region(s).

The modules can include, for example, an owner/AA initiation module 124, a box allocation module 125, an owner/AA authentication module 126, an inventory module 127, a command module 128, and a tracking module 129. It should be appreciated that various functionalities of the systems disclosed herein can be carried out by one or more of the specifically enumerated modules disclosed, or alternatively by other modules of the system that may not be explicitly disclosed but are configured to carry out the disclosed functionality.

The system 100 also includes a user device 140 associated with an owner O, and a user device 150 associated with an AA. The owner O owns at least one article stored in a box 106 in the repository 102. The owner O can also be an AA of the box 106 with which they are associated. In addition, another AA is depicted in the figure. This AA has at least some conditional permission to access the owner O's article from its box 106, but, in this example, is not themselves an owner of the article. It should be appreciated that the system 100 can accommodate a plurality of owners of boxes 106 and a plurality of AA's for any box. One owner O and one AA are depicted in the figure for simplicity of explanation.

The user devices (140, 150) are I/O devices that enable their respective users to interact with other components of the system 100, such as the server 120, typically through a user interface on the user device. In some examples, the user devices (140, 150) can be a computing device configured to connect via a network (such as the Internet) to other components of the system 100. Such computing devices can include, e.g., personal computers, smart phones, tablets, watches or other wearable technology, etc.

The various components (e.g., the user devices 140, 150, the delivery vehicle 110, the courier vehicle 114, the repository 102, and the server 120 of the system 100 interact via a data communication network (“network”) 160, e.g., the Internet. Additionally, in some examples, the various interactive components of the system 100 can interact via one or more application program interfaces (API).

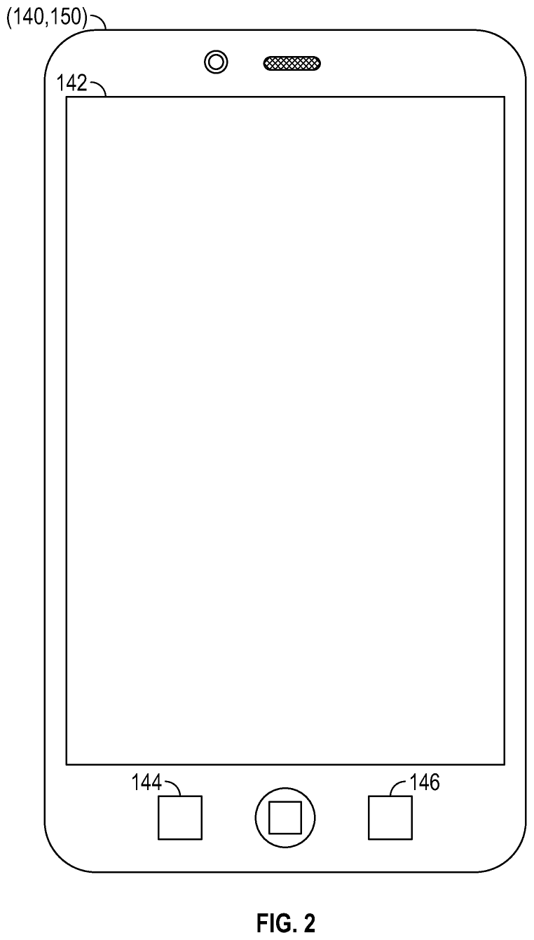

FIG. 2 is a schematic illustration of an example user device (140, 150), of FIG. 1.

In some examples, the user device (140, 150) includes a user interface 142. The user interface 142 provides an interacting platform between the owner/AA and the system 100. The user interface 142 can provide output provided by, and/or receive input required b, the system's various program modules. The user device (140, 150) can include any suitable medium 146 for input and output of information, including but not limited to one or more of a touch/display screen, a voice command interface, a keyboard, a mouse, etc. For purposes of illustration, each user device (140, 150) will be presumed to have a graphical user interface for displaying information, as depicted in some of the figures.

Each user device (140, 150) can include a positioning device 144 that communicates with the system 100 via the network 160. The location of the user device (140, 150) at any given time can be determined by any appropriate positioning device (144) or system using such a positioning device. Non-limiting examples of such positioning devices and systems include, e.g., global positioning systems and devices, cellular tower triangulation, and Internet of Things (TOT) devices, which can be used to track the user device based on its proximity to an object with a known location. In some examples, the positioning device locates the user device based on the user device's connectivity to a particular Wi-Fi network associated with a known location.

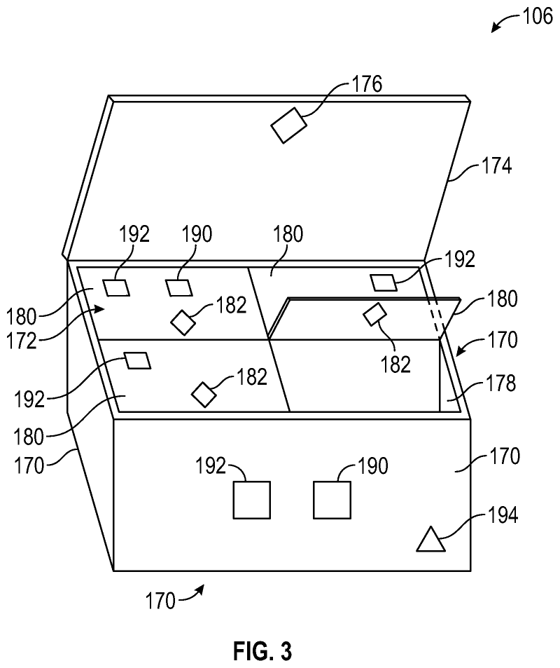

FIG. 3 is a schematic illustration of an example safety box 106 of FIG. 1. The safety box 106 is an openable and closable enclosure having one or more walls 170 that define an interior volume 172. An access door 174 provides selective access to the interior volume 172. One or more locking mechanisms 176 allow the access door 174 to be securely locked to prevent access to the interior volume 172.

In this example, the interior volume 172 is divided into a plurality of compartments 178. In this example, four compartments are depicted, though any suitable number of compartments could be constructed. Each of the compartments includes a closable and lockable door 180, each door 180 including one or more locking mechanisms 182 configured to allow the door 180 to be securely locked to prevent access to the interior of the compartment. Each compartment 178 can be assigned and/or hold a specific article or subset of articles of all the articles of the box 106. Typically, the entire box 106 (all compartments) will be assigned to a single articles owner. In some examples, however, the different compartments 178 can be assigned to a plurality of articles owners, particularly if the owners are somehow interpersonally associated, such as relatives, friends, professional colleagues, business partners, etc.

Each box 106, and each compartment within a box, can be assigned a unique identifier (such as an identification number). Identifiers can help the system 100 locate and track boxes within the system. Readable tags (e.g., RFID tags, bar codes, etc.) can be placed on or in the boxes and compartments to assist in such location and tracking. Identifiers/trackers can also be attached to or embedded in the articles themselves. Identifiers can also be uniquely associated with owners/AA's, enabling owners/AA's to summon a particular article or articles using the box/compartment identifier. The readable and/or trackable tags can be configured to communicate with other components the system 100 via the network 160.

In some examples, the box (and/or individual compartments within the box) can include one or more authentication devices 192. The authentication devices 192 are configured to authenticate the identity of a person attempting to access the box or compartment of the box by capturing information (e.g., a password, biometric information) relevant to authentication. An identity confirmed as that of an owner/AA associated with the box/compartment can result in the locking mechanism 182 unlocking to allow access to the box or compartment, particularly if all other conditions for opening the box/compartment are met. An unauthenticated identity can cause the locking mechanism 182 to remain locked and/or to send a notification/alarm to an owner/AA of the box/compartment and/or the storage trustee of an unauthorized attempt to gain access to the box/compartment. Examples of authentication devices 192 include, e.g., cameras, biometric scanners (e.g., an eye scanner, a fingerprint scanner), genetic testers, voice recognition devices, password entry interfaces, etc. The authentication devices 192 can be configured to communicate with other components of the system 100 via the network 160.

In some examples, the box (and/or individual compartments within the box) can include a theft deterrence system 190. The theft deterrence system 190 can be designed to deter unauthorized access and/or unauthorized attempts to access the articles held in the box 106. For example, the theft deterrence system can include one or more of armor, additional locks, an electromagnetic field, alarms, etc. The theft deterrence system 190 can be configured to communicate with other components of the system 100 via the network 160.

In some examples, the box 106 can include a positioning device 194 that communicates with the system 100 via the network 160. The location of the box 106 at any given time can be determined by any appropriate positioning device 194 or system using such a positioning device. Non-limiting examples of such positioning devices and systems include, e.g., global positioning systems and devices, cellular tower triangulation, and Internet of Things (TOT) devices, which can be used to track the user device based on its proximity to an object with a known location. In some examples, the positioning device locates the user device based on the user device's connectivity to a particular Wi-Fi network associated with a known location.

The location of a box can be a precondition to allowing an owner/AA to access the box. For example, even an authenticated user/AA can be denied access to a box 106 if the location of the box is not deemed sufficiently safe by the system 100. Thus, the system 100 can cross-reference the actual location of a box against a pre-defined set of safe (and/or unsafe) locations to determine if the box is in a safe enough place to permit the owner/AA to access the desired article(s) within the box 106.

Referring again to FIG. 1, the owner/AA initiation module 124 is configured to initiate new owners and AA's to the system 100. The owner/AA initiation module 124 processes information about a prospective owner/AA of the system 100 and ensures that sufficient information has been provided. Such information can include owner/AA identifying information, such as name, address, date of birth social security number, etc. If insufficient information has been provided, the owner/AA initiation module 124 can cause the system 100 to prompt the prospective owner/AA for additional information. In some examples, the owner/AA initiation module 124 can perform one or more functions to verify the information provided.

The owner/AA initiation module 124 can also be configured to request, collect and process authentication information about the new owner/AA which can be used later as a cross-reference to confirm or disconfirm the identity of a person attempting to access a box containing the owner's article(s).

To the extent an owner desires to permit access to a box by AA's other than themselves, the owner/AA initiation module can process identity and authentication information regarding such additional AA's as well.

The authentication information collected can align with a predefined security protocol and can include, for example, biometric information, login/password information, genetic information, photographic information, etc.

The owner/AA initiation module 124 can be also be configured to request, collect, and process payment information for the owner/AA's use of one or more box(es). One or more payment plans can be offered and the owner/AA can enter sufficient information (e.g., credit card or bank account information) for initial and/or ongoing payments to be remitted to a service provider, such as the storage trustee.

In addition, the owner/AA initiation module 124 can pass identity, authentication, payment, and other information to one or more databases for future retrieval by the system 100.

The box allocation module 125 is configured to request, collect, and/or process information about articles to be secured in boxes and then assign boxes to those articles. Thus, for example, the box allocation module 125 can request an owner to provide information about articles to be stored, such as type of article, size, weight, etc. The box allocation module 125 can also request an owner to provide access permission information for each article. For example, a the box allocation module can request, collect and process article access information for each AA associated with the owner's articles, such as who the AA is, what article(s) they are permitted to access, and under what conditions (e.g., temporal conditions, co-dependent AA conditions, etc.) they are permitted to access those articles.

Based on the information concerning the articles and the access permissions, the box allocation module 125 is configured to assign one or more boxes and/or compartments 178 within boxes 106 to the article(s) identified by the owner/AA. In addition, the box allocation module 125 can assign, (e.g., with box or compartment-specific identifiers) boxes and/or compartments within boxes to all of the people who may be granted access to that box/compartment.

It should be appreciated that the size, number, and type of article, as well as the access permissions, can impact how the boxes and compartments are allocated. By way of a few non-limiting examples: firearms may be kept in separate box from documents; articles with different sets (even if partially overlapping) of AA's can be assigned different lockable compartments in the same box; and excessively large articles may be allocated oversize boxes.

It should also be appreciated that the system 100 can accommodate multiple repositories, and therefore the box allocation can also depend on the proximity of the owner/AA's to the different repositories. Thus, the box allocation module 125 can assign and allocate boxes based on physical storage location of the boxes.

The box allocation module 125 can also be configured to handle an existing owner/AA's changes to the articles entrusted to the boxes. For example, if the owner/AA decides to add an article to a box or permanently remove an article from a box, the box allocation module 125 can be configured to allocate space in a box/compartment for the new article, or reallocate the box space previously occupied by the now permanently removed article.

The owner/AA authentication module 126 can be configured to process authentication information (e.g., biometrics information, passwords, other identity credentials) provided to the server 120 by a person attempting access to a box 106. For example, the owner/AA authentication module 126 can request and collect authentication information by the attempted accessor of a given box, and cross-reference that information against that previously provided by the AA's of that box to see if there is a match. If there is a match and all other conditions for accessing the box are met, the owner/AA authentication module 126 can cause the box to unlock. If there is not a match and/or if all accessing conditions are not met, the owner/AA authentication module 126 can prevent the box from unlocking and/or trigger a notification or alarm indicating an unauthorized attempted access of the box.

The inventory module 127 can be configured to maintain and modify a virtual inventory of each article stored in each box 106 and each compartment 178 managed by the system 100. The inventory module 127 can assign an article identifier (e.g., a unique number) to each article and associate that number with information about that article, such as what the article is, who the owner of the article is, who the AA's of the article are, which box and/or compartment the article is stored in, a history of deposits and retrievals of the article, and an image (e.g., a digital photograph) of the article. A database of the system 100 can include memory blocks, each associated with individual boxes, each block including inventory information about the articles stored in that box. In some examples, the inventory module 127 can be configured to read and write to such memory blocks.

The command module 128 can be configured to initiate and monitor the robotic or autonomous dynamics inherent in the system 100. For example, the command module 128 can, in response to an owner/AA's request (via their user device 140, 150) to access a box 106 at a meeting point M, cause: a delivery vehicle 110 to move into position to receive the box 106; and/or cause a courier vehicle 114 to fetch the box 106 from the vault 104, secure the box 106 and enter the internal chamber 112 of the delivery vehicle; and/or cause the delivery vehicle 110 carrying the box 106 to travel as close to the meeting point M as it can safely and reasonably do; and/or cause the courier vehicle 114 to exit the delivery vehicle 110 and meet the owner/AA at the meeting point M; and/or, in response to proper AA authentication, cause the box 106 to open for the AA; and/or cause the box 106 to close, lock and secure when the AA's transaction is complete; and or cause the courier vehicle 114 with the re-secured box to re-enter the delivery vehicle 110 following the transaction; and/or subsequently cause the delivery vehicle to return to the repository 102 or to another meeting point; and/or to subsequently cause the box 106 to be returned to the vault 104.

The command module 128 can be configured to retrieve information from databases or other portions of the system 100 to determine if preconditions for issuing a given command have been met. For example, the command module 128 can retrieve a box's 106 location information, an attempted accessor's authentication information, and/or an attempted accessor's location in order to determine whether or not to issue an unlock command to the box 106.

The tracking module 129 can work with positioning devices on the boxes 106, the stored geographical maps, the delivery vehicles 110, the courier vehicles 114, the article(s), and/or the owner/AA devices (140, 150) to collect, process, and provide information to the other modules (such as the command module 128) and other components of the system regarding the whereabouts of the boxes 106, delivery vehicles 110, courier vehicles 114, articles, and/or owner/AA devices (140, 150). Thus, for example, the tracking module 129 can provide information to a user device of an owner/AA regarding the location of a box en route to a meeting point M.

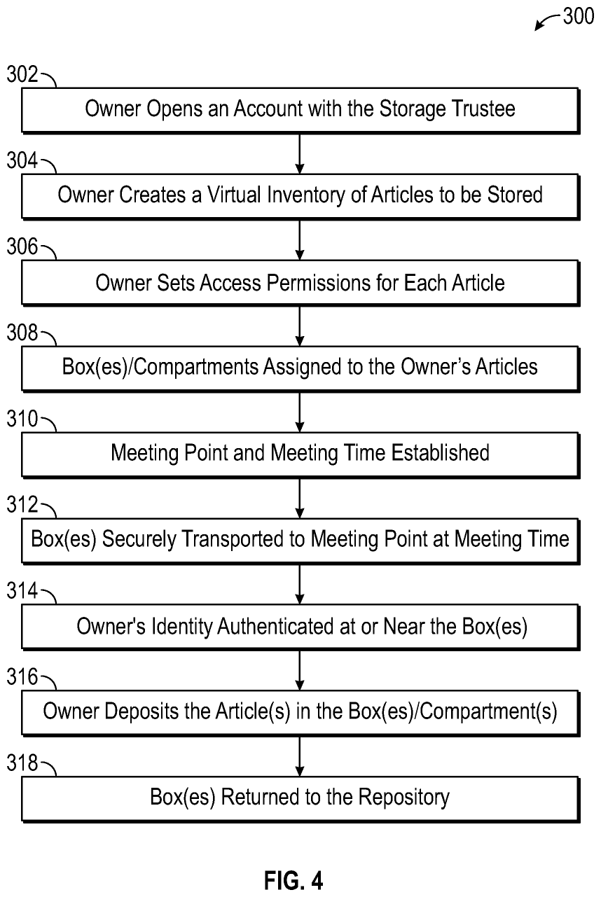

FIG. 4 is a flow diagram illustrating an example of an article depositing process 300 that can be performed in conjunction with the system 100 of FIG. 1. It should be appreciated that the methods and processes described in this disclosure need not be performed in the order presented.

Referring to FIG. 4, in a step 302 an owner O of a stamp collection, a Will, and a pistol opens an account with a storage trustee whereby the storage trustee will store the owner's valuables in a secure repository and make the valuables accessible to one or more people when conditions set by the storage trustee and/or the owner are met.

In some examples, owners and other users (e.g., AA's) of the system 100 downloads and installs a software application on their user device (140, 150) that electronically links the device to the system 100. Once installed on the user device (140, 150), the software application can enable new users to initiate a new account with the system 100, and an existing user (i.e., an existing owner/AA) to connect to and use the system 100. In some examples, access to a user's account on the system 100 requires logging in with credentials to verify the user's identity and authorization to use the account in question.

In exchange for the services provided by the storage trustee, the owner can pay a fee. In the step 302, the owner can provide to the system information such as personal/login information, login and password information by which the owner can access their account, payment information, and/or authentication information (e.g., security questions and answers, biometric information, etc.).

In a step 304, the owner can create a virtual inventory of articles to be stored by the storage trustee. In this example, the owner creates a virtual inventory of three articles, including the stamp collection, the Will, and the pistol. The user can enter information about each of the articles, and that information can be stored in a database 122. The virtual inventory can include a photographic, holographic or other visual component to help identify the stored articles. For example, the owner can upload photographic images of each of the articles using their user device 140, which can later be used by owners/AA's to select articles for retrieval.

In a step 306, the owner can create access permissions and conditions for each of the articles to be stored. In this example, the owner sets different permissions and conditions for each of the three articles. For example, for the stamp collection, the owner can provide sufficient information to the system to establish the owner as an independent AA and each of the owner's children as co-dependent AA's of the stamp collection, who are authorized to access the stamp collection at any time as long as all of the children submit their authorization of that access. With respect to the Will, the owner can, for example, provide sufficient information to the system to establish the owner as an AA at any time, and the owner's spouse and children as independent AA's if and only if the owner is deceased or incapacitated. With respect to the pistol, the owner can, for example, provide sufficient information to the system to establish the owner as the only AA. Due to the dangerous nature of the pistol, the system 100 can also prompt the owner to provide special authentication credentials for accessing the pistol. For example, the owner can be prompted to enter information from their firearm carrying license.

In a step 308, a box 106 is assigned to the owner's articles. In this example, the box assigned is securable and has at least three separately securable compartments 178. The box and each of the compartments can be associated with unique identifiers.

In a step 310, a meeting point and time are determined for the owner to place the articles in the box. In some examples, the owner can select a preferred meeting point, and the system 100 processes the selection to determine if that location is sufficiently secure. If the owner's preferred location is not deemed sufficiently secure, a different location can be negotiated as the meeting point.

Once the meeting point is established, in a step 312 the box is transported to the meeting point with, e.g., a delivery vehicle 110 and/or a courier vehicle 114.

In a step 314 an authentication device 192 (which can be disposed, e.g., on the box 106) authenticates the owner and opens the box and three compartments.

In a step 316, the owner deposits each of the three articles in their assigned compartments and the compartments and the box are locked.

In a step 318 the box is returned (e.g., in the delivery vehicle 110 and/or the courier vehicle 114) to the repository 102 and securely stored, e.g., in a vault, until the box is summoned at some future time by an AA.

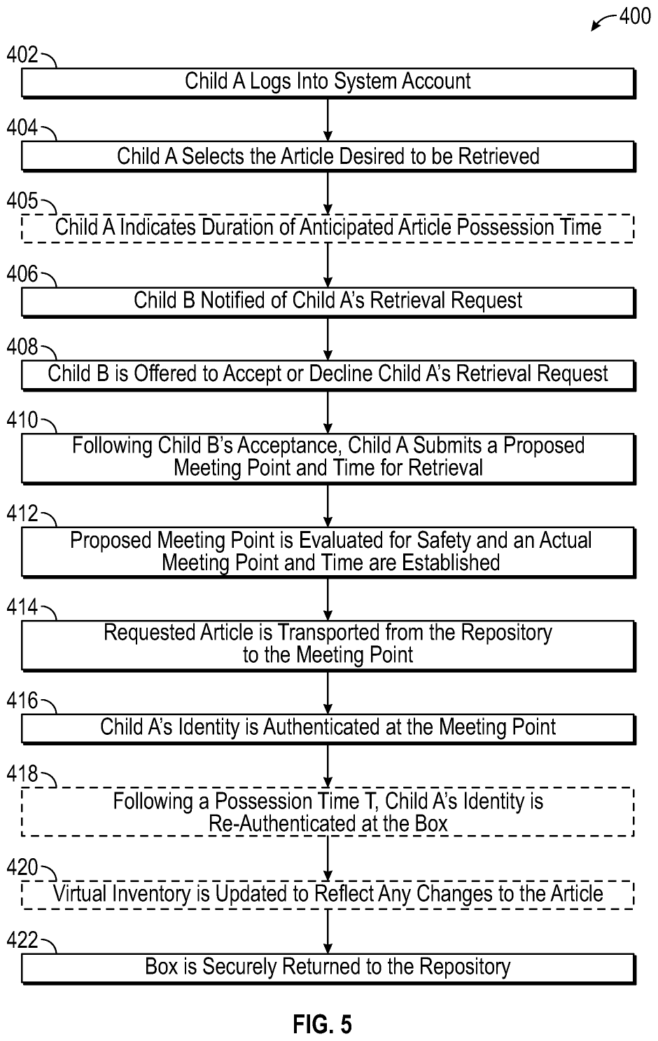

FIG. 5 is a flow diagram illustrating an example of an article retrieval process 400 that can be performed in conjunction with the system 100 of FIG. 1. In this example the retrieval process 400 will be described in connection with the articles deposited as described above with respect to the process 300.

In a step 402, Child A, one of the owner's two total children, uses a software application on their user device 150 to login to their AA account with the system 100 and pull up a virtual inventory of the box 106 with which they are associated.

In a step 404 Child A selects an icon showing an image of the stamp collection to indicate that Child A desires to retrieve the stamp collection from the repository 102.

Optionally, in a step 405 Child A indicates a duration of time T for which they desire to maintain possession of the stamp collection. Alternatively, Child A can indicate that they wish to hold the stamp collection indefinitely.

In a step 406 Child B, the other of the owner's two children, is notified of Child A's request to retrieve to the stamp collection for the requested duration of time of possession T.

In a step 408 Child B has an option to permit or deny Child A's requested retrieval.

In a step 410, following Child B's granting permission to Child A, Child A submits, via their user device 150, a meeting point and time to retrieve the stamp collection.

In a step 412, the system 100 determines if the requested meeting point is sufficiently safe and either confirms the requested meeting point and time, selects a different meeting point deemed sufficiently safe, or proposes one or more alternative meeting points selectable by Child B.

The system 100 can be configured to consider a number of parameters in determining the security adequacy of a given potential meeting point, e.g., the time of day, the time of year, the weather or predicted weather at the requested meeting time, the last reported criminal activity in the area, the nature of the article(s) being retrieved, whether a security guard will be accompanying the transport, etc.

In a step 414 the box 106 containing the stamp collection is pulled from the vault at the repository 102 and placed in the courier vehicle 114 and/or the delivery vehicle 110 and transported to the established meeting point at the appointed time.

In a step 416 an authentication device 192 (e.g., on the box 106) authenticates Child A as an AA and opens the box and the compartment 178 holding the stamp collection.

Optionally, depending on the requested duration of possession T, the box can stay with Child A until Child A re-deposits the stamp collection therein or, alternatively, the box can be returned to the repository. If the box is returned to the repository during the interim time T, optionally the system 100 can be configured to notify Child A when the time T has expired or is going to expire and another meeting point and time can be arranged for the box and Child A to meet for the re-deposit. Optionally, if Child A has opted to retrieve the stamp collection for an indefinite period, Child A can be responsible for submitting a request to establish another meeting time and place for the deposit.

In a step 418, Child A is re-authenticated by the box 106 (e.g., with the authentication device 192), the box and the compartment in the box are opened, and Child A returns the stamp collection to the compartment.

Optionally, in a step 420, to the extent the article has been modified while in the AA's possession (e.g., while in possession of the stamp collection Child A adds stamps to the stamp collection or removes stamps from the stamp collection), Child A can update the box's virtual inventory to reflect such changes. For example, images of any new stamps added to the collection can be uploaded to the system 100 and associated with that article of inventory. In addition or alternatively, written information regarding any changes to the articles of the box 106 can be uploaded to the system 100.

In a step 422, after the stamp collection has been returned to the box, the box is securely returned to the repository 102, e.g., by being transported in the courier vehicle 114 and/or the delivery vehicle 110.

It should be appreciated that the steps of processes for retrieving and/or re-depositing articles in a box (of which the process 400 is an example) can vary depending on, e.g., the type of AA requesting the retrieval (e.g., independent, exclusive, co-dependent), the duration of the retrieval, and any modifications made to the article contents of the box as a result of the retrieval.

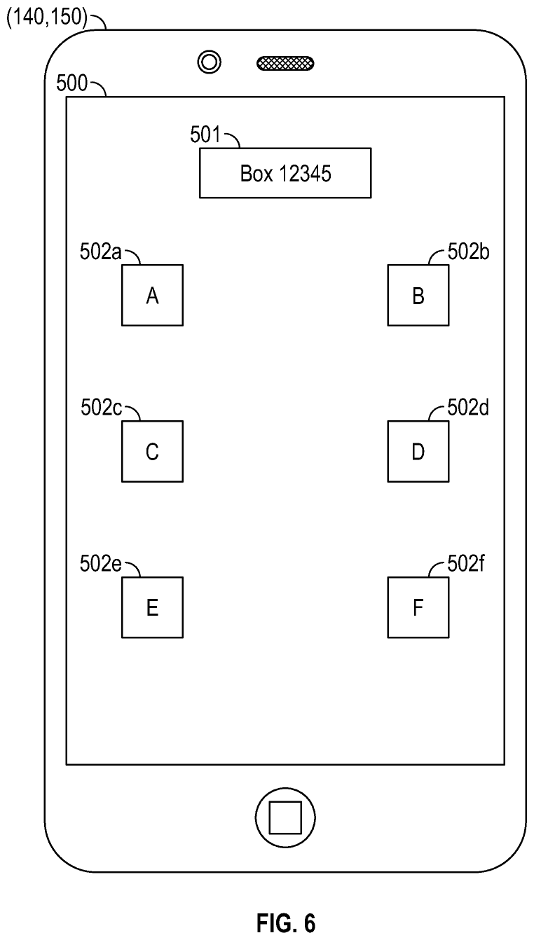

FIG. 6 depicts an example schematic interface display 500 showing an example input screen on the user interface 142 of the user device (140, 150) of FIG. 2. The display 500 is an example virtual inventory screen and includes a plurality of selectable icons 502a, 502b, 502c, 502d, 502e, 502f (collectively, 502). Each icon 502, for example, can correspond to an article stored in a box at the repository 102 and display an image of that corresponding article. In this case, the box in question is identified in the banner 501 of the display 500.

As mentioned, the icons 502 can include images of the articles they represent. In addition, the visual appearance of the icons 502 can reflect other information about those articles. For example, if a particular article has been checked out by another AA and is therefore not in the box, the icon 502 for that article can indicate as such, e.g., by being greyed out or not selectable. As another example, if the AA who has logged in and opened the inventory page is an AA of some but not all of the articles in that inventory, the icons representing the non-accessible articles can indicate as such. As another example, the icons 502 can indicate whether the consent of other co-dependent AA's is required prior to retrieving the article in question.

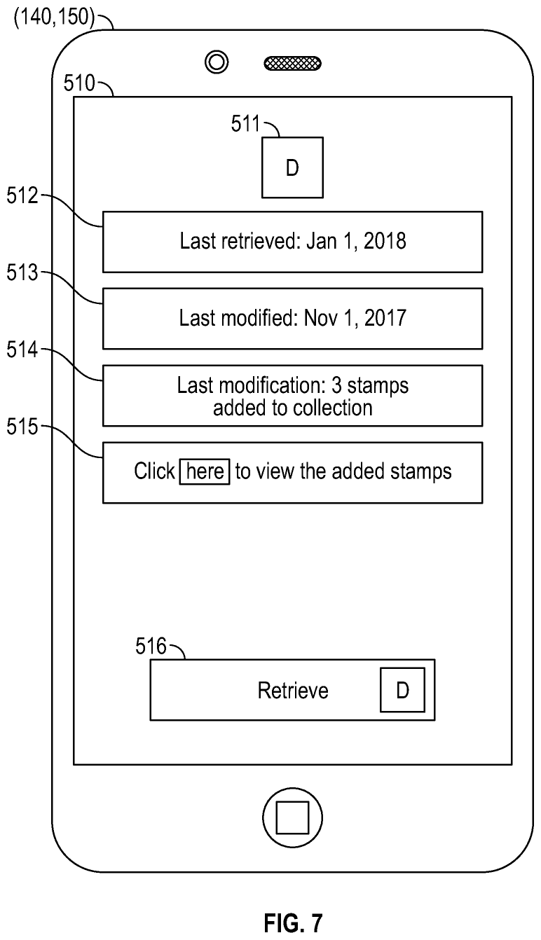

Once an icon has been selected, additional information about the article can be displayed, such as its history of deposits and retrievals, its history of modifications, etc. FIG. 7 depicts an example schematic interface display 510 showing a further example input screen on the user interface 142 of the user device (140, 150) of FIG. 2. In particular, FIG. 7 depicts an example display that could follow selection of the icon 502d of FIG. 6.

The display 510 includes a banner 511 indicating the selected article. The display 510 also includes information 512 about the date of last retrieval, information 512 about the date of last modification, and information 514 about the nature of the latest modification. A prompt 515 invites the AA to view the modification to the article. In this example, the AA is either an independent or exclusive AA of the indicated article and is therefore also provided with a selectable prompt 516 to retrieve that article. Selecting the prompt 516 can, for example, generate a further input/output display in which a meeting point and time can be negotiated for the AA to retrieve the selected article.

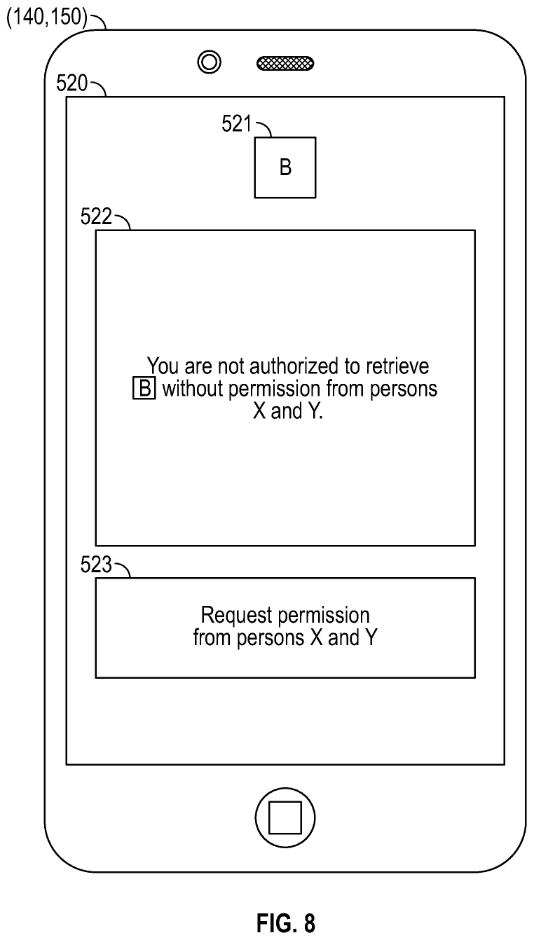

FIG. 8 depicts an example schematic interface display 520 showing a further example input screen on the user interface 142 of the user device (140, 150) of FIG. 2. In particular, FIG. 8 depicts an example display that could follow selection of the icon 502b of FIG. 6. A banner 521 indicates the article that has been selected. In this case, the prospective AA who has selected the icon 502b is neither an exclusive AA nor an independent AA, but is rather a co-dependent AA who must obtain permission from the other co-dependent AA's in order to retrieve the desired article. Block 522 provides information regarding the conditions that must be met for the prospective AA to be permitted to retrieve the desired article. A prompt 523 invites the prospective AA to follow a protocol to meet conditions necessary for retrieval (in this case, the conditions include obtaining permission from other co-dependent AA's of the article in question). The protocol may include prompting the user for additional information about the desired retrieval, e.g., the desired length of the retrieval or any plans to modify the article while retrieved, as such information may be relevant to obtaining the needed permissions from co-dependent AA's.

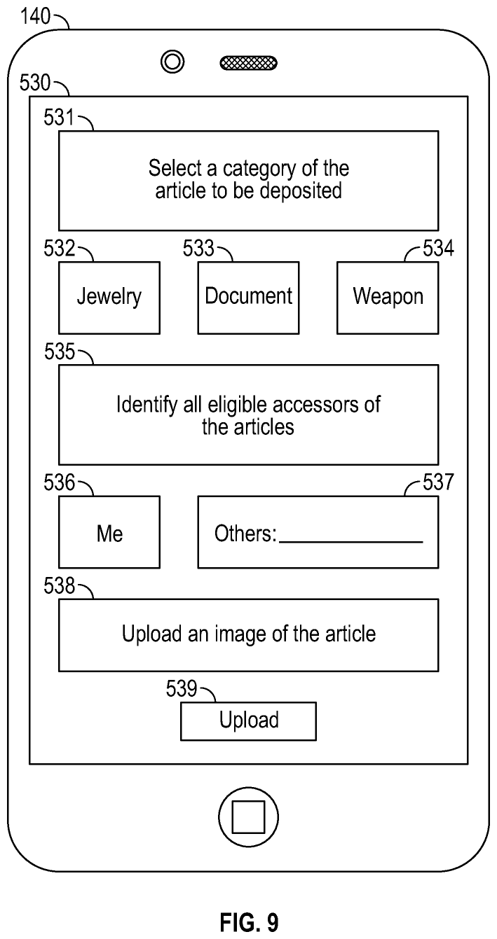

FIG. 9 depicts an example schematic interface display 530 showing a further example input screen on the user interface 142 of the user device 140 of FIG. 2. In particular, FIG. 9 depicts an example display that could be presented on the user device 140 of an owner who intends to deposit a new article in a box. The box could already contain or not contain other articles belonging to the owner. Thus, in some examples, the owner can be a recently initiated user of the system 100; in other examples, the owner can be a preexisting user of the system with other articles already stored in the box in question and/or in a different box.

The display 530 includes a prompt 531 inviting the owner to select and enter one of a plurality of selectable categories (such as pre-defined categories 532, 533, and 534) that characterizes the article to be deposited. The category selected can, e.g., help the system 100 choose an appropriate box for the article. Additional information, such as the articles' size, weight, color, etc., can also be entered.

The display 530 also includes a prompt 535 inviting the owner to identify any eligible AA's for the article. In this example, the owner themselves is selectable via the option 536, and a user definable list of other AA's can be entered via the data input 537.

The display 530 also includes a prompt 538 inviting the owner to upload an image of the article to be deposited. Once an image has been selected (e.g., an image stored on the owner's user device 140), in this example an upload button 539 can be selected to execute uploading of the image to the virtual inventory stored in a database 122 of the system 100.

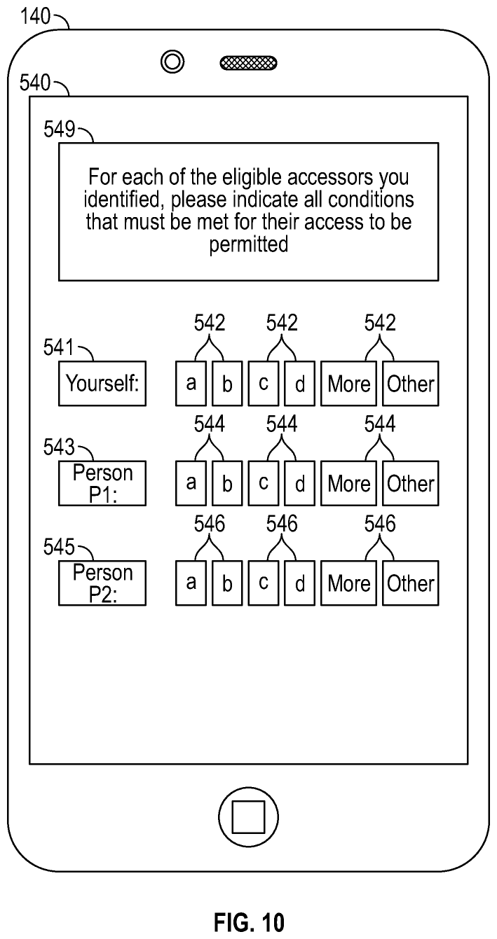

FIG. 10 depicts an example schematic interface display 540 showing a further example input screen on the user interface 142 of the user device 140 of FIG. 2. In particular, FIG. 10 depicts an example display that could be presented following the display 530 of FIG. 9.

The display 540 includes a prompt 549 inviting the owner to input any conditions that are to attach to the AA's already identified before the those AA's are permitted access to the article from the box. In this example, it is assumed that the owner has identified themselves and two other people (P1, P2) as eligible AA's. A prompt 541 invites the owner to input any conditions that attach to the owner's own access of the article. The owner can select from one or more conditions 542 that can include predefined conditions, user definable conditions, or a “no conditions” option. Similarly, with respect to the first AA P1 indicated at prompt 543, the owner can select from one or more conditions 544 that can include predefined conditions, user definable conditions, or a “no conditions” option. Similarly, with respect to the second AA P2 indicated at prompt 545, the owner can select from one or more conditions 546 that can include predefined conditions, user definable conditions, or a “no conditions” option.

The system attaches any entered AA conditions to the article in question and updates the virtual inventory as appropriate. Once all the conditions for all of the AA's have been selected and entered into the system 100, the system can negotiate a meeting point and time with the owner at which the owner can perform the initial deposit of the article in question into a particular box or particular compartment of a particular box.

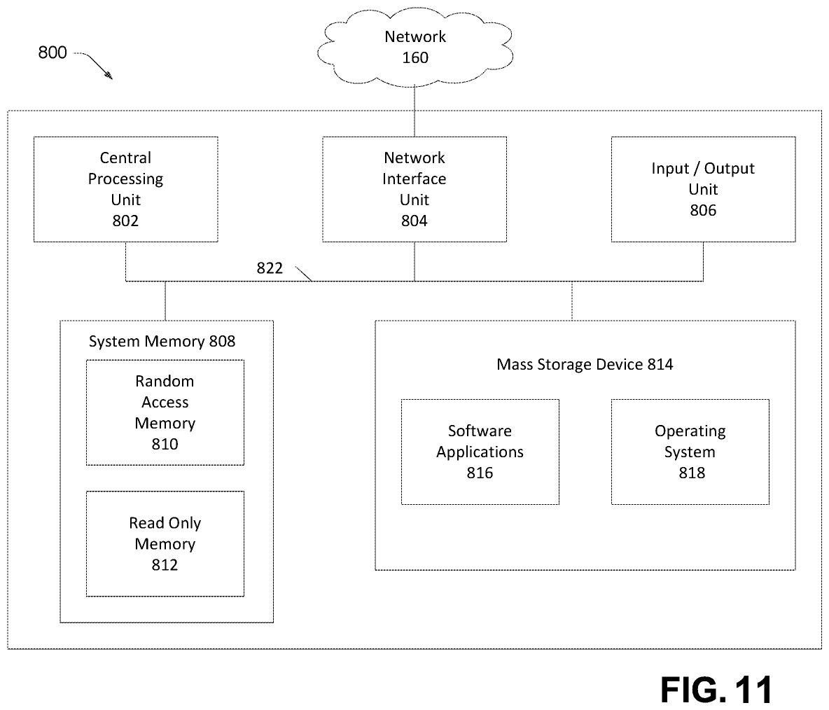

FIG. 11 schematically illustrates an example computer system suitable for implementing aspects of the system 100 illustrated in FIG. 1, such as the server 120, and/or the user devices (140, 150). The modules, databases, and other components of these servers and devices could all be implemented on a common computer system, or the various components could be implemented on one or more separate computer systems that are accessible by one another.

The computer 800, which may be a server computer, for example, includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the server computer 800, such as during startup, is stored in the ROM 812. The computer 800 further includes a mass storage device 814. The mass storage device 814 is able to store software instructions and data. One or more of the databases (e.g., the database(s) 122) of the system could be implemented by the mass storage device 814, or one or more of the databases could be implemented by other computer systems accessible by the computer 800.

The mass storage device 814 is connected to the CPU 802 through a mass storage controller (not shown) connected to the system bus 822. The mass storage device 814 and its associated computer-readable data storage media provide non-volatile, non-transitory storage for the server computer 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 800.

According to various embodiments, the server computer 800 may operate in a networked environment using logical connections to remote network devices (such as the others of the server 120, the user device (140, 150)) through the network 160, such as a wireless network, the Internet, or another type of network. The server computer 800 may connect to the network 160 through a network interface unit 804 connected to the system bus 822. It should be appreciated that the network interface unit 804 may also be utilized to connect to other types of networks and remote computing systems. The server computer 800 also includes an input/output controller 806 for receiving and processing input from a number of other devices, including the user interface 142 generated on the user device (140, 150), which could include a touch user interface display screen, or another type of input device, as described above. Similarly, the input/output controller 806 may provide output to a touch user interface display screen or other type of output device.

As mentioned briefly above, the mass storage device 814 and the RAM 810 of the server computer 800 can store software instructions, software applications 816, and other data. The software instructions include an operating system 818 suitable for controlling the operation of the server computer 800. The mass storage device 814 and/or the RAM 810 also store software instructions, that when executed by the CPU 802, cause the server computer 800 to provide the functionality of the server computer 800 discussed in this document. For example, when the server computer 800 corresponds to the server 120, the mass storage device 814 and/or the RAM 810 can store software instructions that, when executed by the CPU 802, cause the server computer 800 to implement the owner/AA initiation module 124, the box allocation module 125, the owner/AA authentication module 126, the inventory module 127, the command module 128, and/or the tracking module 129, and any other modules incorporated to perform the various functionalities described.

Although various embodiments are described herein, those of ordinary skill in the art will understand that many modifications may be made thereto within the scope of the present disclosure. Accordingly, it is not intended that the scope of the disclosure in any way be limited by the examples provided.

1. A system for storing and retrieving articles, comprising:
a plurality of securable boxes, the boxes being lockable and unlockable;
a repository for storing the securable boxes;
a delivery vehicle;
at least one readable and writable data storage device storing, for at least a first of the boxes containing an article, a virtual inventory including data associated with one or more articles stored in the first box, the one or more articles including the article;
at least one processor; and
memory encoding instructions that, when executed by the at least one processor, causes:
determination of one or more pre-defined locations at which the first box is permitted to be unlocked;
retrieval of the first box containing the article selected from the virtual inventory and transportation of the first box from the repository to a meeting point via the delivery vehicle, the meeting point being remote from the repository, the meeting point being at or close to one of the one or more pre-defined locations;
identity authentication or non-authentication of a person attempting to access the article at the meeting point;
location of the delivery vehicle;
retrieval of access permissions and conditions of access for the article, the access permissions and conditions including requiring permission from a first person to permit access to the article by a second person, and permission from the second person to permit access to the article by the first person;
determination that the person is one of the first person or the second person;
determination of whether the person has access permission for the article, including requesting, using a user interface of an electronic device, of permission for the person to access the article from the other of the first person;
if the person has access permission for the article, determination of whether the person meets conditions of access for the article;
in response to an identity authentication, a determination that the delivery vehicle is at a location of the meeting point, and a determination that the person has access permission for the article and meets the conditions of access for the article, unlocking of the first box to permit access to the article;
in response to an identity non-authentication, not unlocking of the first box;
capture of one or more images of each of the one or more articles; and
storage of a modification history to the article based upon the one or more images of each of the one or more articles.

2-3. (canceled)

4. The system of claim 1, wherein the data associated with each of the one or more articles includes one or more conditions that must be met prior to a retrieval of the one or more articles.

5-6. (canceled)

7. The system of claim 1, wherein there are at least two authorized accessors who are independently authorized to access the article.

8. The system of claim 1, wherein the delivery vehicle is an autonomous vehicle.

9. The system of claim 1, further comprising an autonomous courier vehicle, the courier vehicle being smaller than the delivery vehicle and adapted to securely carry at least the first of the boxes from the delivery vehicle to the meeting point.

10. The system of claim 1, wherein at least the first box stores a plurality of articles and includes a plurality of internal compartments, the plurality of articles being stored in the plurality of compartments.

11. The system of claim 10, wherein each of the plurality of compartments is separately lockable and unlockable.

12. The system of claim 11, wherein in response to an identity authentication, the processor causes an unlocking of a first of the compartments and does not cause an unlocking of a second of the compartments.

13. The system of claim 1, wherein the meeting point is at least partially determined by comparing a proposed meeting point with location information stored on the at least one storage device to determine if the proposed meeting point meets a predefined threshold level of security.

14. The system of claim 1, wherein at least the first box includes an authentication device adapted to collect at least one of a password, an image, or biometric information.

15. A computer implemented method comprising:
depositing at least one article in a lockable and unlockable box;
storing the box in a repository;
predefining one or more locations at which the at least one article can be safely removed from the lockable and unlockable box;
requesting, by a requestor, access to the at least one article at a meeting point remote from the repository;
determining if the meeting point satisfies a predefined threshold level of security;
determining whether the requestor has access permission for the at least one article and meets conditions for accessing the at least one article based on access permissions and conditions for the at least one article, the access permissions and conditions including requiring permission from a first person to permit access to the at least one article by a second person, and permission from the second person to permit access to the at least one article by the first person, including determining that the requestor is the first person or the second person and requesting, using a user interface of an electronic device, permission from the other of the first person or the second person to access the at least one article;
when the meeting point satisfies the predefined threshold of security, and when the requestor has access permission for the at least one article and meets the conditions for accessing the at least one article, transporting the box containing the at least one article in an autonomous vehicle to the meeting point remote from the repository;
authenticating, at the meeting point, an identity of the requestor; and
in response to the authenticating, unlocking the box to provide the requestor access to the at least one article.

16. The method of claim 15, wherein the box comprises an authentication device for authenticating the requestor.

17. The method of claim 15, wherein the requesting comprises selecting the at least one article from a virtual inventory, the virtual inventory comprising visual representations of each of the at least one article.

18-19. (canceled)
